(19) United States
(12) Patent Application Publication
(10) Pub. No.: US 2004/0122760 A1
(43) Pub. Date: Jun. 24, 2004

(54) Apparatus and method for document content trading

(76) Inventors: Scott H. Clearwater, Portola Valley, CA (US); Charles A. Untulis, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/326,089

(22) Filed: Dec. 23, 2002

(51) Int. Cl. G06F 17/60

(52) U.S. Cl. 705/37

(57) ABSTRACT

A method and corresponding apparatus for document content trading use a content trading system (CTS) to automatically allocate publication resources in a production workflow or manufacturing process. The CTS acts as a marketplace infrastructure for providing goods, services and processes for CTS vendors and CTS customers. Specifically, the CTS enables the CTS customers, such as advertisers, to buy publication spaces from the CTS vendors, such as publishers. The CTS also enables the advertisers to trade among other advertisers for the other advertisers' publication spaces. Publication spaces thus become a fungible entity, and the publishers no longer need to manually lay out content of a publication.

### CROSS-REFERENCE TO RELATED PATENT APPLICATIONS

This application is related to commonly assigned U.S. patent application Ser. No. ______ (Attorney Docket No. 100202496-1), entitled “APPARATUS AND METHOD FOR MARKET-BASED DOCUMENT CONTENT AND LAYOUT SELECTION” to Scott H. CLEARWATER; U.S. patent application Ser. No. ______ (Attorney Docket No. 100202497-1), entitled “APPARATUS AND METHOD FOR MARKET-BASED DOCUMENT CONTENT SELECTION” to Scott H. CLEARWATER; U.S. patent application Ser. No. ______ (Attorney Docket No. 10018740-1), entitled “APPARATUS AND METHOD FOR CONTENT RISK MANAGEMENT” to Scott H. CLEARWATER; U.S. patent application Ser. No. ______ (Attorney Docket No. 100110399-1), entitled “APPARATUS AND METHOD FOR MARKET-BASED GRAPHICAL GROUPING” to Henry W. SANG, Jr., et al., and U.S. patent application Ser. No. ______ (Attorney Docket No. 10019320-1), entitled “APPARATUS AND METHOD FOR MARKET-BASED DOCUMENT LAYOUT SELECTION” to Henry W. SANG, Jr., et al., all of which are concurrently herewith being filed under separate covers, the subject matters of which are herein incorporated by reference.

### TECHNICAL FIELD

The technical field relates to document management systems, and, in particular, to document content trading systems.

### BACKGROUND

The advent of the Internet and desktop publishing has drastically altered the magnitude and variety of documents published. Highly customized documents can be created for a reasonable cost, and users are no longer forced to consume a one-size-fits-all product due in part to the large setup and production costs in older systems. In addition, printed publication has provided a convenient forum for advertising. However, publishers often struggle with the task of finding the right advertisers for the right advertising space and the right price. Similarly, advertisers often seek the right publication for the right advertising space and the right price to reach the right end-consumer.

Currently, publishers have to manually and laboriously lay out all the advertisements and have to negotiate with advertisers for space and fees. Similarly, the advertisers have to individually negotiate with the publishers for the best price and the best space. In addition, individual subscribers are generally unable to customize publication of an advertisement.

### SUMMARY

A method for document content trading includes creating a content trading system (CTS) and defining criteria for trading. The criteria for trading include available publication spaces. The method also includes announcing the CTS to potential customers, publishing the criteria for trading, and receiving publication contents from one or more customers. The one or more customers generate bids for the available publication spaces. The method further includes consummating a trade of the publication contents among the one or more customers through the CTS.

A corresponding apparatus for document content trading includes one or more vendors that define criteria for content trading, such as available publication spaces, and one or more customers that generate bids for the available publication spaces. The apparatus further includes one or more content trading systems (CTSs) capable of receiving publication contents from the one or more customers and consummating a trade of the publication contents among the one or more customers. The one or more customers interact with the one or more CTSs through one or more interfaces.

### DESCRIPTION OF THE DRAWINGS

The preferred embodiments of the method and apparatus for document content trading will be described in detail with reference to the following figures, in which like numerals refer to like elements, and wherein:

FIG. 1 illustrates an exemplary content trading system (CTS) that interacts with CTS vendors and CTS customers, according to one embodiment of the present invention;

FIG. 2 illustrates an example where the exemplary CTS of FIG. 1 interacts with publishers as CTS vendors and advertisers as CTS customers in a business to business modality, according to another embodiment of the present invention;

FIG. 3 illustrates another example where the exemplary CTS of FIG. 1 interacts with advertisers as CTS vendors and end-users or end-consumer as CTS customers in a business to consumer modality, according to another embodiment of the present invention;

FIG. 4 illustrates yet another example where multiple CTSs are chained or linked together, according to another embodiment of the present invention;

FIG. 5 illustrates still another example where the CTS of FIG. 1 is operated by a trade show organizer, according to another embodiment of the present invention;

FIG. 6 illustrates yet still another example where an end-user as CTS customer interacts with different CTSs, according to another embodiment of the present invention;

FIG. 7 is a flow chart illustrating an exemplary operation of the CTS of FIG. 1, according to another embodiment of the present invention; and

FIG. 8 illustrates exemplary hardware components that may be used in connection with the method for document content trading, according to another embodiment of the present invention.

### DETAILED DESCRIPTION

A method and corresponding apparatus for document content trading use a content trading system (CTS) to automatically allocate publication resources in a production workflow or manufacturing process. The CTS acts as a marketplace infrastructure for providing goods, services and processes for CTS vendors and CTS customers. Specifically, the CTS enables the CTS customers, such as advertisers, to buy publication spaces from the CTS vendors, such as publishers. The CTS also enables the advertisers to trade among other advertisers for the other advertisers' publication spaces. Publication spaces thus become a fungible entity, and the publishers no longer need to manually lay out content of a publication.

The CTS is an enabling technology that creates a highly permeable two-way interface between the CTS vendors (vendors) and the CTS customers (customers). In a CTS-enabled business, a customer can directly influence the workflow of a vendor's process. The vendor, in turn, can directly influence the customer's future purchases by learning the preferences of the customer over time. Specifically, the CTS is a business process model for a computerized infrastructure that provides a mechanism for buying and selling various goods, services, and processes. As a provider of goods, the CTS may be owned by a vendor that uses the CTS as a means of interacting with customers. As a provider of a service, the CTS takes a vendor's preferences and provides an interface and marketplace in which customers (subscribers) trade with the vendor and other customers. As a provider of a process, the CTS ties the customer directly into the vendor's workflow by, for example, allowing a customer to move the customer's order up or down in a queue based on trading with another customer. By providing a common interface to and a marketplace for the three aspects of a business, i.e., goods, services, and processes, the CTS removes the duality between the customer and the vendor, making the customer and the vendor an integrated whole.

The CTS may be used across enterprises or within an enterprise to affect a new level of efficiency, thus increasing the effectiveness of the vendor's products to the customer. The CTS can also suggest other venues or find a service or process for a customer. Such functionality is especially useful to an end-consumer, because the CTS typically tunes itself to the end-consumer's interests and preferences.

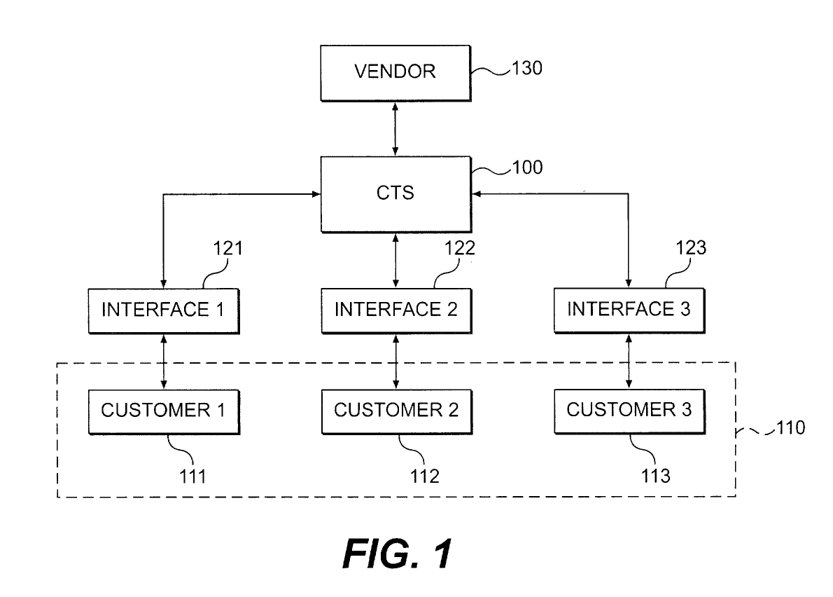

FIG. 1 illustrates an exemplary CTS 100 that interacts with CTS vendors 130 and CTS customers 110. Customers 110, such as customer₁ 111, customer₂ 112, and customer₃ 113, typically interact with the CTS 100 through interfaces, such as interface₁ 121, interface₂ 122, interface₃ 123, respectively. The interfaces 121, 122, 123 may be in the forms of an email, an onscreen avatar, or notification through any other devices such as PDAs and cell phones or the like. In addition, the interfaces 121, 122, 123 can use custom “rings” to notify a customer of a particular kind of activity, such as an interesting buy or sell offer. The custom rings may be defined by a customer profile. The customer profile typically defines what events on the CTS are interesting to a particular customer.

The CTS 100 receives a list of publications and the available spaces for the publications. The list of publications may be, for example, next month's advertising pages for a newspaper. The CTS 100 then publishes, for example, on a web page, minimum prices for the publication spaces, various processes, various materials or the like. Subscribers to the CTS 100, i.e., potential customers and advertisers 110, then generate bids for the publication spaces. Different auction mechanisms may be used by the CTS 100 in selecting the “winner” or “owner” of the publication spaces. For example, sealed-bid auction may be used where the highest bid wins. In addition, Dutch auction may be used where the nth highest bid wins. British auction may also be used where the bids start low and go higher until no one bids higher. The winner is the highest bidder. Additionally, open bidding may be used, for example, up to publication time. Open bidding is especially applicable to web advertisers. Additionally, a combination of open bidding and closed bidding may be used.

Depending on the type of the auction, the owner of the publication spaces may later resell the spaces owned, possibly at a higher price, if resell is allowed in the subscription contract. The publisher (vendor 130) may obtain an agreed upon amount from the resell transaction. To prevent speculators from cornering or otherwise manipulating the market, the CTS owner, i.e., the vendor 130 in FIG. 1, can provide the CTS 100 with a list of approved traders. The vendor 130 thus has the option of making the CTS 100 a subscription service and can legally constrain participants to ethical behavior to protect against collusion, malicious compliance, and other destructive behavior. The vendor 130 can also decide how much automation is allowed in a trade. For example, the vendor 130 may decide to manually approve all transactions, or to allow fully automated trading without owner intervention.

The CTS 100 may interact with a market-based trading system that coordinates trades among the document objects. Market-based trading systems have been used in a wide variety of applications to optimize the performance of a computer system or to allocate resources. The market-based trading systems automatically consummate trades among objects in a documents based on user preferences, efficiently generating high value documents.

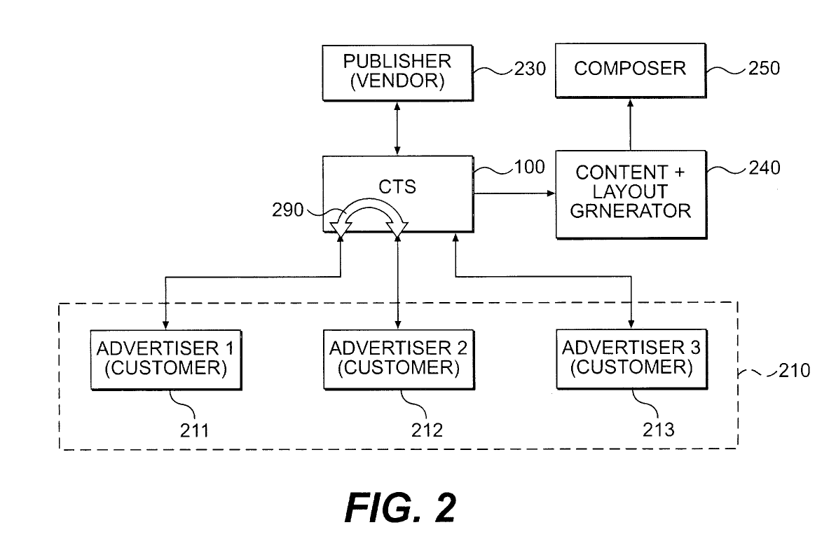

FIG. 2 illustrates an example where the exemplary CTS 100 interacts with publishers 230 as CTS vendors and advertisers 210 as CTS customers in a business to business modality. The exemplary CTS 100 is described in connection with advertising space trading for illustration purposes only. One skilled in the art will appreciate that the CTS 100 can be applied equally well for providing other types of goods, services and processes.

Referring to FIG. 2, the CTS 100 may provide a market mechanism for allocating advertising spaces in various media such as newspapers, magazines, catalogs, web pages or the like. In other words, the advertising spaces are traded through the CTS 100. The advertisers 210, such as advertiser₁ 211, advertiser₂ 212, and advertisers 213, typically interact with the publisher 230 through the CTS 100. The arrow 290 inside the CTS 100 connects the two advertisers 211, 212 and provides a path for the two advertisers 211, 212 to coordinate or swap the two advertisers' publication content on a page or spread. For example, a seller of tires may want to advertise on the same spread as a car dealer, and it may be advantageous for both the car dealer and the tire seller to be juxtaposed on the spread to reinforce the notion of cars and car parts in a reader's mind. Thus, the car dealer may disclose the car dealer's identity as the owner of certain advertising space in order to generate a serendipitous sale of adjoining advertising spaces. The tire seller may also ask the car dealer to sell part of the car dealer's space to the tire seller in order to reinforce the car imagery but at a lower cost to both advertisers.

The advertisers 210 typically supply the CTS 100 with a complete publishable description of the advertisement, including the content, space, process, material (for example, special paper) or the like. The publisher 230 has the option of reviewing at any time the content offered through the CTS 100. The publisher 230 can verify that the content conforms to various guidelines as set forth by a general agreement with the CTS customers, the advertisers 210 in this example. Additionally, the advertisers 210 may communicate among one another, if the advertisers are visible to each other. The advertisers 210 may then negotiate terms of trading, which can be settled through the CTS 100. After the trade is completed, the CTS 100 may send the trading result to a content and layout generator 240 and a composer 250 to construct the publication.

In the above example, the CTS 100 provides a marketplace for the advertisers 210 to buy and sell advertising spaces in a publication. The CTS 100 may also enable the advertisers 210 to determine when and where their advertisements will appear in a publication and to whom the publication will be sent. From the advertiser standpoint, the CTS 100 provides a mechanism for achieving one-to-one marketing without having to incur additional infrastructure costs. Since the CTS 100 can provide a data mining capability, the focus of the advertisements can be customer-centric rather than product-centric. Data mining means using one or more characteristics of a database to find other characteristics. For example, age and time of year may be used to identify products for specific groups of customers, such as toboggans for young people. Additionally, the CTS 100 affords more effective marketing by the advertisers 210 in either a “pull” mode by the customers from the advertisers 210 or a “push” mode from the advertisers 210 to the customers.

In the advertising domain, the CTS 100 may offer custom publishing as well as the possibility of increased advertising revenue. For example, the advertisers 210 may decide directly where on a page to place the advertisements rather than having an editor decide or negotiate with the advertisers 210. In addition, the advertisers 210 may set an initial fee to pay for an advertising space through an auction mechanism. Additionally, automation of advertisement placement reduces lead time to press so that advertising spaces can be sold up to the last minute. Once the initial advertising space is auctioned off by the CTS 100, the CTS 100 may collect a fee for every subsequent transaction involving the advertisers 210 trading among one another, collecting more fees from traders.

As a result, the advertisers 210 have a more effective way to target advertising spaces based on other advertisements and the advertisers' end-consumer preferences. Likewise, end-consumers may benefit by receiving customized publications with advertisements targeted for the end-consumers' needs based on either profile information or past usage. In addition, the publisher 230 no longer has to oversee entire layout process or to bargain with the advertisers 210 on fees.

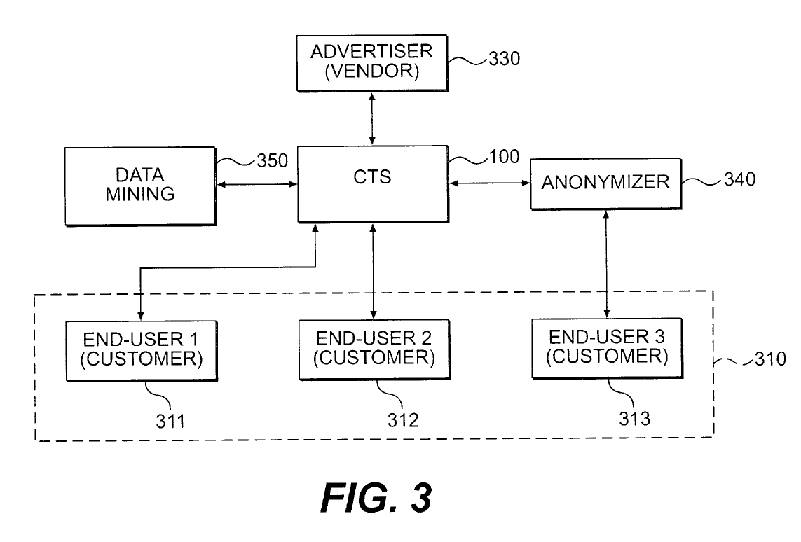

FIG. 3 illustrates another example where the exemplary CTS 100 interacts with advertisers 330 as CTS vendors and end-users or end-consumer 310 as CTS customers in a business to consumer modality. Similar to FIG. 2, the exemplary CTS 100 is described in connection with advertising space trading for illustration purposes only. One skilled in the art will appreciate that the CTS 100 can be applied equally well for providing other types of goods, services and processes.

Referring to FIG. 3, the advertising spaces are traded through the CTS 100. The end-users 210, such as end-user₁ 211, end-user₂ 212, and end-user₃ 213, typically interact with the advertiser 230 through the CTS 100. The end-users 310 can affect the content of the end-users' own advertisements, which are typically based on a profile or end-users' previous usage.

Issues of privacy may exist in the business to consumer modality. For example, an end-user 310 may not want his or her identity revealed to the advertiser 330. The privacy issue can be resolved through an anonymizer service 340 that prevents either the end-user 310 or advertiser 330 from knowing each other's identity. In the case of magazine advertisements, the magazine publisher (not shown) may know which advertisement goes to which address. If the advertiser 330 owns the CTS 100, the advertiser 330 ultimately decides what the rules are regarding, for example, the anonymity of the traders (end-consumers 310 in this example). The CTS 100 shown in FIG. 3 has data mining 350 and anonymizer 340 features. In this example, the anonymizer 340 feature is used by the end-user₃ 313 only.

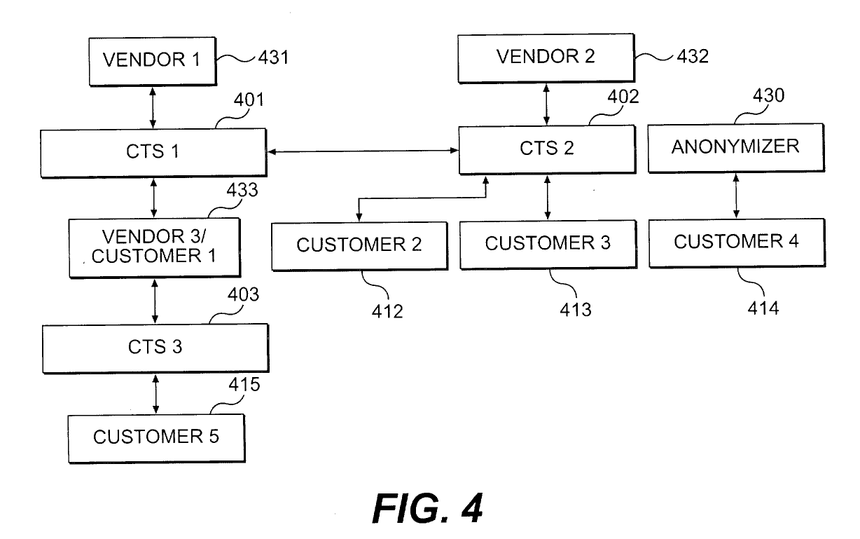

FIG. 4 illustrates yet another example where multiple CTSs 401, 402, 403, 404 are chained or linked together. Customers 433, 412, 413, 414, 415 interact with vendors 431, 432, 433 through the multiple CTSs 401, 402, 403, 404. The vendor₃ 433 in this example is also the customer₃ 433 of the vendor₁ 431.

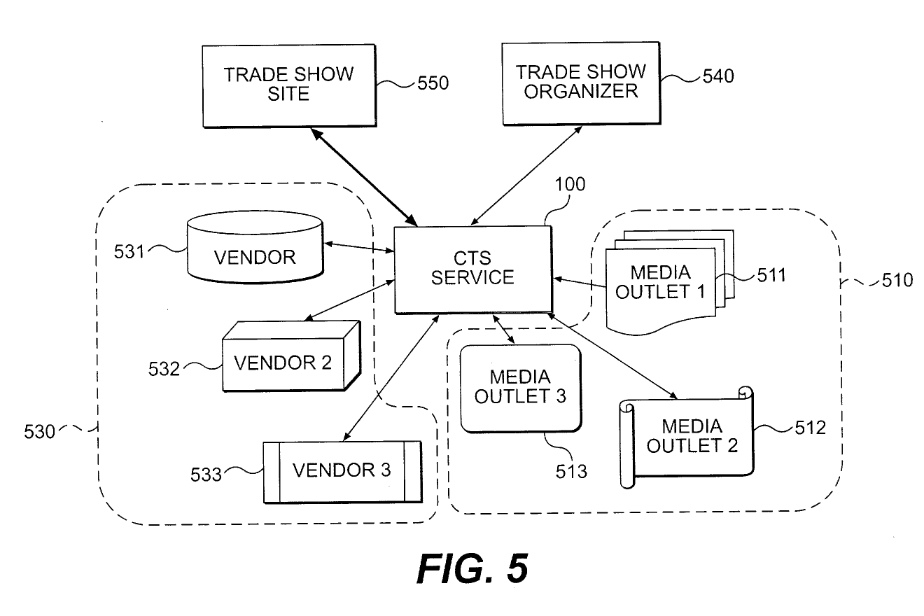

FIG. 5 illustrates still another example where the CTS 100 is operated by a trade show organizer 540. Instead of having to deal with media outlets 510 for advertising and vendors 530 vying for advertising spaces on a trade show site 550, the trade show organizer 540 may let the vendors 530 compete for advertising spaces through the CTS 100. The media outlets 510 also may compete to obtain the advertising business. The trade show organizer 540 provides the CTS 100 with criteria or parameters, such as raw materials for the advertising spaces, the trading site, and the amount of money to be spent on the advertisements.

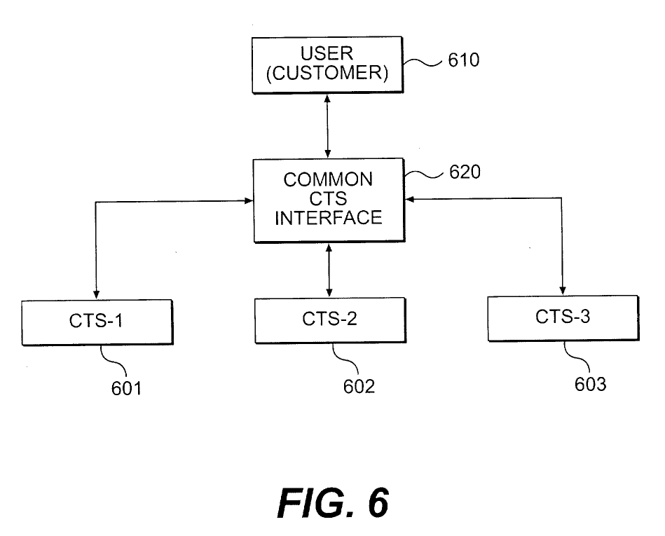

FIG. 6 illustrates yet still another example where an end-user 610 as CTS customer interacts with different CTSs 601, 602, 603 through a generic CTS interface 620. The multiple CTSs 601, 602, 603 may each represent sets of bidders, and may then be bidders for higher level auctions. For example, a farmer may bid for silo space as part of a cooperative. The cooperative may then bid with other cooperatives or commercial silo operators to bid for space in other silos. These examples are provided for illustration purposes only. One skilled in the art will appreciate that the CTS 100 can be applied equally well for other types of trading.

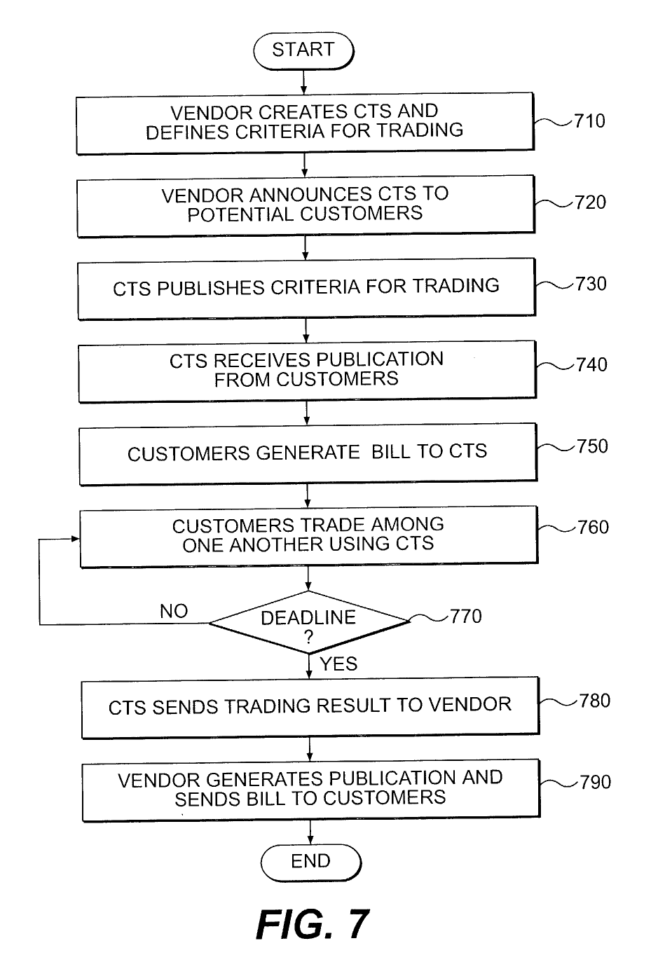

FIG. 7 is a flow chart illustrating an exemplary operation of the CTS 100 of FIG. 1. The vendor 130 creates an instance of the CTS 100 and defines criteria for trading (block 710). The criteria may include minimum prices for publication spaces, various processes, various materials or the like. Then, the vendor 130 announces the CTS 100 to potential customers 110 (block 720). Next, the CTS 100 publishes the criteria for trading, for example, on a web page (block 730). Customers 110 willing to participate may send publication description to the CTS 100 (block 740). The description may include content, space, process, material for the publication or the like. Then, the customers 110 generate bid to the CTS 100 for available publication spaces (block 750). The customers 110 then may trade among one another using the CTS 100 (block 760) until a deadline is reached (block 770). Afterwards, the CTS 100 sends the trading result to the vendor 130 (block 780). The vendor 130 then generates the publication based on the trading result and generates bills to be sent to the customers (block 790).

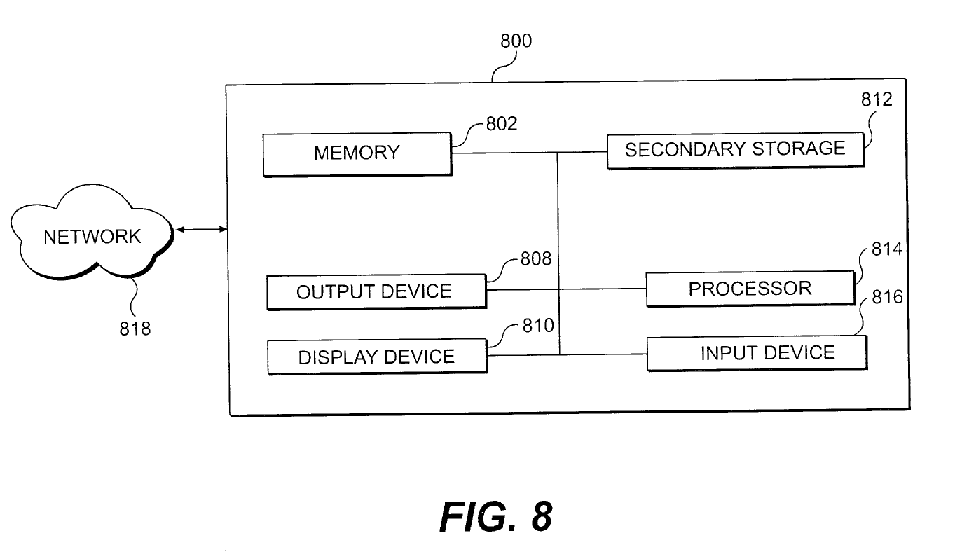

FIG. 8 illustrates exemplary hardware components of a computer 800 that may be used in connection with the method for document content trading. The computer 800 includes a connection with a network 818 such as the Internet or other type of computer or telephone network. The computer 800 typically includes a memory 802, a secondary storage device 812, a processor 814, an input device 816, a display device 810, and an output device 808.

The memory 802 may include random access memory (RAM) or similar types of memory. The secondary storage device 812 may include a hard disk drive, floppy disk drive, CD-ROM drive, or other types of non-volatile data storage, and may correspond with various databases or other resources. The processor 814 may execute information stored in the memory 802, the secondary storage 812, or received from the Internet or other network 818. The input device 816 may include any device for entering data into the computer 800, such as a keyboard, keypad, cursor-control device, touch-screen (possibly with a stylus), microphone or the like. The display device 810 may include any type of device for presenting visual image, such as, for example, a computer monitor, flat-screen display, display panel or the like. The output device 808 may include any type of device for presenting data in hard copy format, such as a printer or printing device, and other types of output devices including speakers or any device for providing data in audio form. The computer 800 can possibly include multiple input devices, output devices, and display devices.

Although the computer 800 is depicted with various components, one skilled in the art will appreciate that the computer 800 can contain additional or different components. In addition, although aspects of an implementation consistent with the method for document content trading are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 800 to perform a particular method.

While the method and apparatus for document content trading have been described in connection with an exemplary embodiment, those skilled in the art will understand that many modifications in light of these teachings are possible, and this application is intended to cover any variations thereof.

What is claimed is:

1. A method for document content trading, comprising:
creating a content trading system (CTS), wherein the creating step includes defining criteria for trading, and wherein the criteria for trading include available publication spaces;
announcing the CTS to potential customers;
publishing the criteria for trading;
receiving publication contents from one or more customers, wherein the one or more customers generate bids for the available publication spaces; and
consummating a trade of the publication contents among the one or more customers through the CTS.

2. The method of claim 1, further comprising sending a trading result to a vendor for publishing.

3. The method of claim 1, further comprising generating a publication based on a trading result.

4. The method of claim 1, further comprising sending bills to the one or more customers.

5. The method of claim 1, further comprising notifying the one or more customers of a particular kind of a trading activity.

6. The method of claim 1, wherein the consummating step includes using auction mechanisms to trade the publication contents through the CTS.

7. The method of claim 1, wherein the consummating step includes using sealed-bid auction mechanisms to trade the publication contents through the CTS.

8. The method of claim 1, wherein the consummating step includes using Dutch auction mechanisms to trade the publication contents through the CTS.

9. The method of claim 1, wherein the consummating step includes using British auction mechanisms to trade the publication contents through the CTS.

10. The method of claim 1, wherein the consummating step includes using open bidding auction mechanisms to trade the publication contents through the CTS.

11. The method of claim 1, wherein the consummating step includes using a combination of open-bidding and closed bidding auction mechanisms to trade the publication contents through the CTS.

12. The method of claim 1, wherein the publications are advertisements.

13. The method of claim 1, further comprising reselling publication spaces to another customer through the CTS.

14. The method of claim 1, further comprising coordinating the publication contents by customers from a related industry.

15. The method of claim 1, wherein the publishing step includes publishing the criteria for trading on a web page.

16. An apparatus for document content trading, comprising:
one or more vendors that define criteria for content trading, wherein the criteria include available publication spaces;
one or more customers that generate bids for the available publication spaces; and
one or more content trading systems (CTSs) capable of receiving publication contents from the one or more customers and consummating a trade of the publication contents among the one or more customers,
wherein the one or more customers interact with the one or more CTSs through one or more interfaces.

17. The apparatus of claim 16, further comprising an anonymizer service capable of preventing an identity of the one or more customers to be revealed.

18. The apparatus of claim 16, wherein the one or more CTSs are linked together.

19. The apparatus of claim 16, wherein the one or more CTSs are capable of increasing publication revenue for the one or more vendors.

20. A computer readable medium providing instructions for document content trading, the instructions comprising:
creating a content trading system (CTS), wherein the creating step includes defining criteria for trading, and wherein the criteria for trading include available publication spaces;
announcing the CTS to potential customers;
publishing the criteria for trading;
receiving publication contents from one or more customers, wherein the one or more customers generate bids for the available publication spaces; and
consummating a trade of the publication contents among the one or more customers through the CTS.

21. An apparatus for document content trading, comprising:
means for creating a content trading system (CTS), wherein the creating step includes defining criteria for trading, and wherein the criteria for trading include available publication spaces;
means for announcing the CTS to potential customers;
means for publishing the criteria for trading;
means for receiving publication contents from one or more customers, wherein the one or more customers generate bids for the available publication spaces; and
means for consummating a trade of the publication contents among the one or more customers through the CTS.

22. The apparatus of claim 21, further comprising means for sending a trading result to a vendor for publishing.

23. The apparatus of claim 21, further comprising means for generating a publication based on a trading result.

24. The apparatus of claim 21, further comprising means for reselling publication spaces to another customer through the CTS.

25. The apparatus of claim 21, further comprising means for coordinating the publication contents by customers from a related industry.
